(19) United States
(12) Patent Application Publication
(10) Pub. No.: US 2014/0208867 A1
(43) Pub. Date: Jul. 31, 2014

(54) OPEN CHANNEL FLOW METER

(71) Applicant: FloWav, Inc., Hummelstown, PA (US)

(72) Inventors: JOHN BYRD, TONEY, AL (US); DONALD R. SAUER, HUNTSVILLE, AL (US); BRUCE COHEN, OCEAN RIDGE, FL (US)

(73) Assignee: FloWav, Inc., Hummelstown, PA (US)

(21) Appl. No.: 14/243,276

(22) Filed: Apr. 2, 2014

Related U.S. Application Data
(63) Continuation of application No. 13/199,531, filed on Sep. 1, 2011, now abandoned.

(51) Int. Cl. G01F 1/66

(52) U.S. Cl. CPC G01F 1/663
USPC 73/861.25

(57) ABSTRACT

The open channel flow meter of the present invention uses a progressive spectral analyzer to increase the efficiency and accuracy thereof. This is accomplished by using a smaller degree fast Fourier transform covering small sections of the span of the sensor. Additional sections of the span are added to the analysis as required to cover the desired velocity range. This approach also allows one to bypass the processing of velocity spans outside the actual site conditions. This allows circuitry which costs less, uses less power, and achieves more precise readings in a shorter time period.

### CROSS REFERENCE TO RELATED APPLICATION

This application claims the benefit of Provisional Patent Application No. 61/402,653 filed Sep. 2, 2010.

### BACKGROUND OF THE INVENTION

The present invention is directed toward an open channel flow meter and, more particularly, toward an open channel flow meter or sensor that incorporates a progressive spectral analyzer.

There are many Doppler velocity sensors on the market based on the Doppler principal of analyzing the frequency shift of a transmitted signal proportional to the speed of the signal. However, most of these operate in a similar manner and suffer the same mathematical limitations due to their design. These sensors capture the signal reflected from moving particles or moving surfaces of the liquid and analyze the frequency shift using various methods such as a fast Fourier transform (FFT). The frequency shift of the reflected signal is derived by mixing the echoed signal with a local oscillator synchronized to the transmitter frequency.

An analog to digital converter (ADC) samples the signal at a prescribed frequency proportional to the velocity span of the sensor. The FFT resolves the frequency shift into discrete spectral bins representing a finite value of the velocity of the liquid. The FFT is a complex computation that requires an exponential increase in the number of calculations for each higher degree of the FFT. The resolution of the velocity bins is a function of the degree of the FFT and the sampling frequency of the echoed signal.

In order to achieve a specific velocity span e.g. −5 fps to +15 fps, using the current prior art approach, one would sample the Doppler shifted signal at one specific frequency and a specific transmitter and local oscillator. After this velocity span is chosen, then the degree of the FFT divides this span into equal velocity increments, e.g. 20 fps span/1024 bins=0.024 fps increments. With a fixed velocity span, the only way to improve the resolution is to perform a higher degree FFT which requires an exponential increase in the number of computations. This requires faster and more expensive microprocessors or digital signal processors, requires more processing time, and more electrical power.

### SUMMARY OF THE INVENTION

The use of a progressive spectral analyzer with the flow meter of the present invention overcomes many of the limitations of the sensors described above by using a smaller degree FFT covering small sections of the span of the sensor. Additional sections of the span are added to the analysis as required to cover the desired velocity range. This approach also allows one to bypass the processing of velocity spans outside the actual site conditions. This allows circuitry which costs less, uses less power, and achieves more precise readings in a shorter time period than with the current method described above.

One method of achieving this concept can be realized by first performing a low resolution FFT over the entire sensor span to obtain a rough approximation of the actual velocity. Using the same size FFT, selecting a smaller span around the initial approximation and collecting additional signal samples to obtain a higher resolution spectrum. The additional signals are then processed to remove spurious noise elements and improve the quality of the signal. Thereafter, the velocity reading is extracted using the higher resolution spectrum and, if necessary, the span is adjusted to capture higher resolution spectra of different velocity ranges or to achieve higher resolution over a smaller span.

### BRIEF DESCRIPTION OF THE DRAWINGS

For the purpose of illustrating the invention, there is shown in the accompanying drawings forms that are presently preferred; it being understood that the invention is not intended to be limited to the precise arrangements and instrumentalities shown.

FIG. 1 is perspective view, shown somewhat schematically of the open channel flow meter of the present invention in use in a sewer pipe;

FIG. 2 is a view similar to FIG. 1 but with a more accurate representation of a beam that the transmitter injects into the flow;

FIG. 3 is a flow chart in the form of a block diagram illustrating one way of producing a velocity reading using a fast Fourier transform;

FIG. 4 is a flow chart in the form of a block diagram illustrating an example of taking a low resolution velocity reading to get a rough estimate and then adjusting the sampling rate and local oscillator offset to obtain a higher resolution in the area around the estimate, and

FIG. 5 shows graphs illustrating an example of a 256 point spectrum covering a 10 fps span having a resolution of 10 fps/256 bins, or 0.039 fps/bin.

### DETAILED DESCRIPTION OF THE PREFERRED EMBODIMENTS

As is well known in the art, the Doppler effect is the change in the frequency of a wave for an observer moving relative to the source of the wave. This principle applies to a specific case where the transmitter and receiver are in a fixed location, and the transmitted signal is reflected from moving particles in the beam of the transmitter. Thus by measuring the frequency shift of a signal reflected from particles in moving water versus the transmitter frequency, one can calculate the speed at which the particles are moving. A fast Fourier transform (FFT) is a mathematical algorithm for recovering various frequency components from such a signal.

An example of the application of a Doppler velocity sensor in a pipe of flowing liquid, e.g. a sewer pipe, is shown in FIG. 1 wherein the sewer pipe 2 is partially filled with water 3 that is flowing to the right 5 at a nominal velocity. Suspended in the water are particles, bubbles, and other reflective items 4 generally flowing in the same direction and speed as the water. A Doppler velocity sensor 1 is installed in the bottom of the pipe 2 transmitting acoustic signals 7 into the flow and receiving a signal 6 reflected back from the various particles 4 in the water.

A simplified model is shown to illustrate a reflection of the transmitted signal from a single particle. The depth of flow 8 is sufficient to cover the sensor and provide a medium for the signal to project into the water and return a reflected signal. When the transmitted signal reflects off a particle moving at a velocity Vp, the frequency is changed according to the Doppler effect. The signal received by the Doppler velocity sensor contains the velocities of the various reflectors which can be analyzed to determine the average velocity of the flow.

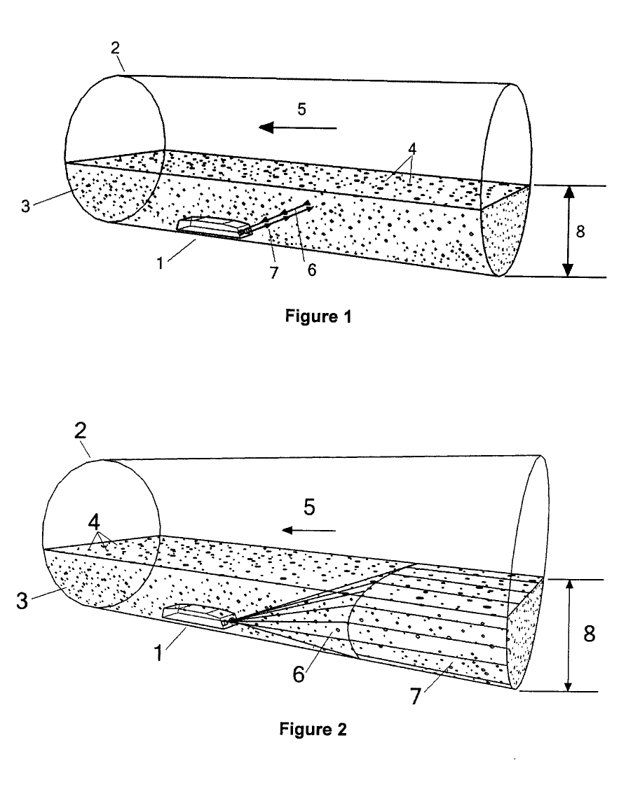

FIG. 2 is a more accurate representation of a beam 6 that the transmitter injects into the flow. The beam is dispersed and reflected by a multitude of reflectors suspended in the water, by the walls of the pipe, by the surface of the water and by turbulence in the flow. Typically the moving particles are traveling in the general direction of the flow and at a speed proportional to the flow. Other researchers have indicated that the velocity varies over the cross section of the flow with slower velocities near the walls of the pipe and faster velocities near the upper center area of the pipe. The average velocity is dependent upon the actual profile at the specific site, but can be estimated from the point velocity information contained in the spectrum.

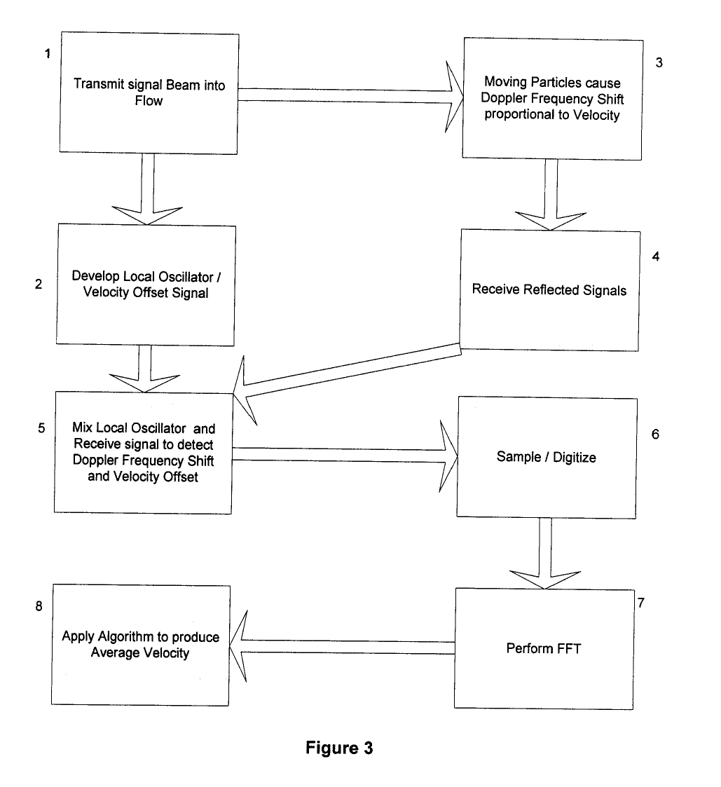

FIG. 3 shows an example of producing a Velocity reading using a FFT. Block 1 illustrates a means of transmitting a signal beam into the flow of water. Block 2 illustrates a means of generating a local oscillator signal which may be the same frequency as the transmit frequency or may be a different frequency to apply a velocity offset. Block 3 illustrates the interaction of the signal with the moving particle and changing the frequency according to the Doppler effect. Block 4 illustrates a means of receiving the Doppler shifted signal reflected from the moving particles. Block 5 illustrates a means of beating the local oscillator signal with the received signal to produce the frequency difference of the two signals. This difference includes the Doppler frequency shift plus any frequency offset applied due to difference of the local oscillator with the transmit frequency.

Block 6 in FIG. 3 illustrates the digitizing of the mixed signal at a pre-specified frequency to form a “time domain” array. The dimension of the FFT to be performed determines the number of digitized samples required, and the velocity range associated with the FFT determines the sampling frequency. Block 7 illustrates the FFT algorithm which produces a “frequency domain” array or spectrum. Each element or bin of the spectrum represents the magnitude of the signal at a discrete frequency. The frequency is correlated to the velocity of particles moving in the water. Block 8 illustrates an algorithm to generate an average velocity from the various spectral bins. In practice, multiple firings are typically performed to improve the accuracy and repeatability of the reading.

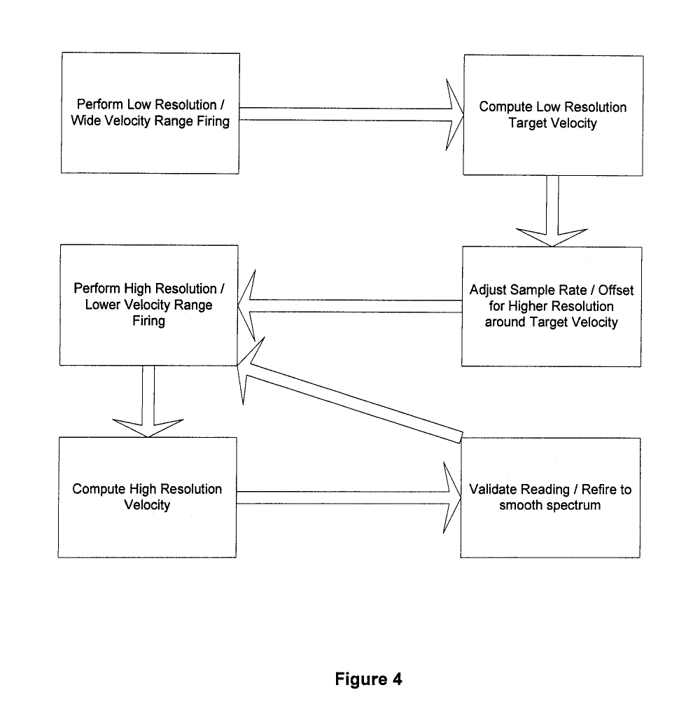

FIG. 4 shows an example of taking a low resolution velocity reading to get a rough estimate, and then adjusting the sampling rate and local oscillator offset to obtain a higher resolution in the area around the estimate. The power/time savings are realized by using smaller dimension FFT and slower sampling rates in a small portion of the overall span.

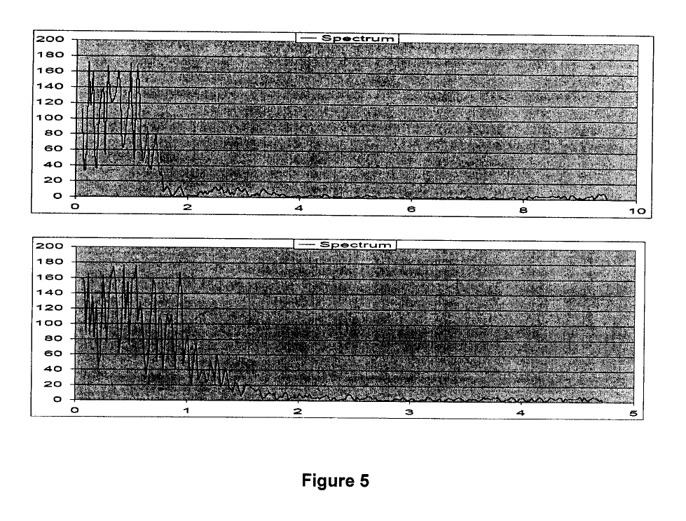

FIG. 5 shows an example of a 256 point spectrum covering a 10 fps span having a resolution of 10 fps/256 bins, or 0.039 fps/bin. This would require sampling the signal at least 2040 Hz. A second firing using the same 256 point spectrum over a 5 fps span has twice the resolution, i.e. 5 fps/256 bins or 0.0195 fps/bin. The second firing requires a sampling rate of at least 1020 Hz.

This method is a significant improvement to the 20 fps span spectrum which requires a 1024 point FFT to achieve the same resolution, 20 fps/1024 bins=0.0195 fps/bin. This method offers the advantage of improving the speed/efficiency using a smaller FFT.

A variation of this method is to use a smaller span and the same size FFT to improve the resolution of the sensor. For example, using the 20 fps span with a 1024-point FFT yields a resolution of 0.0195 fps, whereas choosing a 5 fps span with the same FFT improves the resolution by a factor of 4, i.e. 5 fps/1024 bins=0.0048 fps/bin.

Another variation of this method is to use a local oscillator at a different frequency as the transmitter to apply an offset to the velocity range. For example, if the sensor was transmitting at 250,000 Hz and the local oscillator operates at 250,500 Hz, the spectrum is shifted approximately 5 fps. Shifting the local oscillator to 249, 500 Hz would shift the spectrum about 5 fps in the opposite direction. Thus by changing the frequency of the local oscillator, one can offset the spectrum.

An additional variation of this method is to use programmable filters to assure that spurious high frequency noise are suppressed to maintain the requirements of the Nyquist sampling theory and eliminate the possibility of aliasing. For example, if the span were lowered from 10 fps to 5 fps, then the filter could be changed to prevent frequencies greater than 510 Hz.

The general Doppler equation for a sensor consisting of a stationary transmitter and receiver and a target moving directly toward the sensor:

f_{Doppler}=2*Vₚ*f_{Tx}/c

where:
f_{Doppler}=(Hz)
Vₚ=Velocity of Particle (f/s)
f_{Tx}=Transmit Frequency (Hz)
c=Speed of Sound in Water (f/s)

To illustrate the Doppler effect, consider water flowing in a pipe at 15 f/s at 77 degrees Fahrenheit. At this temperature the speed of sound is approximately 4911 f/s. If a 250 KHz signal is transmitted into the flow, the Doppler shift is 1527 Hz at the receiver. Similarly, water flowing at 1 f/s would have a Doppler shift of 102 Hz.

The span and resolution of the velocity sensor depends on the dimension of the FFT and the frequency at which the received signal is sampled. The number of spectral bins in the FFT is often used in describing the dimension, e.g. a 1024-point FFT has 1024 spectral bins.

Higher dimension FFTs provide better resolution, but requires more computations. The direct computation of an N-point FFT requires an order of N*N computations, whereas more efficient algorithms reduce the number to an order of N*log2 (N) computations. The Cooley-Tukey FFT algorithm is one of the more common efficient implementations of the FFT.

A FFT requires sampling the received signal at a fixed time rate or frequency. The Nyquist Sampling Theory states that the sampling frequency should be at least 2 times the highest frequency present in the signal. Thus, for water flowing at 15 fps, the sample frequency must be greater than 3054 Hz. Similarly water flowing at 1 fps must be sampled at a frequency greater than 204 Hz. Thus, the maximum velocity which can be detected is limited to one half the sampling frequency.

The present invention may be embodied in other specific forms without departing from the spirit or essential attributes thereof and accordingly, reference should be made to the appended claims rather than to the foregoing specification as indicating the scope of the invention.

We claim:

1. A meter for measuring the velocity of liquid flowing in a moving stream comprising:
means for transmitting a signal beam of acoustic signal of a selected frequency into the liquid flowing in the stream;
means for detecting acoustic signals reflected by particles moving with the liquid in the stream;
means for creating a mixed signal from said selected frequency and said detected signals;
means for determining the Doppler frequency shifts of the reflected signal by particles moving with the liquid in the stream versus the transmitted signal;
means for producing a spectrum of amplitude versus Doppler frequency;
means for determining the average velocity of particles of the liquid from the spectrum of the amplitude versus Doppler frequencies.

2. The meter as claimed in claim 1 further including a frequency mixer to detect the frequency differences of the acoustic signals reflected by particles moving with the liquid in the stream and a reference frequency.

3. The meter as claimed in claim 2 further including a local oscillator to generate said reference signal.

4. The meter as claimed in claim 3 wherein said means for determining the average velocity utilizes the amplitudes and velocities of individual bins of the frequency domain spectrum.

5. The meter as claimed in claim 3 further including means for making multiple velocity measurements and for averaging the velocity readings to improve accuracy.

6. The meter as claimed in claim 3 further including means for producing a rough estimate of the velocity by pre-firing the transmitting means to provide a low resolution velocity over a wide velocity span.

7. The meter as claimed in claim 6 further including means for reducing the span of the spectrum to include only the frequencies near the pre-firing estimate for the velocity.
